(19) United States
(12) Patent Application Publication
(10) Pub. No.: US 2010/0249342 A1
(43) Pub. Date: Sep. 30, 2010

(54) PROCESS FOR PRODUCTION OF POLYPHENYLENE SULFIDE RESIN

(75) Inventors: Takeshi Unohara, Aichi (JP); Yoshiki Makabe, Shiga (JP); Naoya Nakamura, Aichi (JP); Kei Saitoh, Aichi (JP); Atsushi Ishio, Aichi (JP); Masahiro Inohara, Aichi (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: TORAY INDUSTRIES, INC., Tokyo (JP)

(21) Appl. No.: 12/741,652

(22) PCT Filed: Nov. 8, 2007
(86) PCT No.: PCT/JP2007/071699

§ 371 Date: May 17, 2010

(51) Int. Cl. C08G 75/14

(52) U.S. Cl. 525/535

(57) ABSTRACT

A process for producing a polyphenylene sulfide resin with properties of (1) 0.3 wt % or less in the amount of the volatile gas generated when heated and melted at 320° C. in vacuum for 2 hours, (2) 0.3 wt % or less in the ash content achieved when incinerated at 550° C., (3) 4.0 wt % or less in the residue amount achieved when a solution with 1 part by weight of the polyphenylene sulfide resin dissolved in 20 parts by weight of 1-chloronaphthalene is pressure-filtered by a PTFE membrane filter with a pore size of 1 μm at 250° C. for 5 minutes, and (4) higher than 500 g/10 min in melt flow rate (according to ASTM D-1238-70: measured at a temperature of 315.5° C. and at a load of 5000 g), by acid-treating a polyphenylene sulfide resin in an acid treatment step and subsequently treating it for thermal oxidation in a thermal oxidation step.

### RELATED APPLICATIONS

This is a §371 of International Application No. PCT/JP2007/071699, with an inter-national filing date of Nov. 8, 2007 (WO 2009/060524 A1, published May 14, 2009), the subject matter of which is incorporated by reference.

### TECHNICAL FIELD

This disclosure relates to a process for producing a polyphenylene sulfide resin excellent in melt flowability, small in metal content and in the amount of the volatile component generated during melting and excellent in molding stability and wet heat resistance.

### BACKGROUND

Polyphenylene sulfide (hereinafter abbreviated as PPS) resins have excellent properties suitable as engineering plastics such as heat resistance, barrier properties, chemicals resistance, electric insulation and wet heat resistance, and are used as various electric/electronic parts, machine parts, automobile parts, films, fibers and the like mainly produced by injection molding and extrusion molding.

However, PPS resins are high in melt-processing temperature owing to their high melting points and are likely to generate volatile components during melt processing. Particularly a PPS resin required to have electric resistance as used for electric/electronic parts is acid-treated to be lowered in metal content. Such a PPS resin remarkably generates a volatile component, to contaminate the mold or to clog the mold vent for causing molding failures as the case may be, and therefore is highly desired to be decreased in volatile component. The volatile component can be decreased by heat-treating the PPS at a temperature of lower than the melting point, but an excessive heat treatment brings about such problems as lower moldability owing to an excessive rise of melt viscosity and to the production of a gelation product. Our process is based on the finding that, if an acid-treated PPS resin is subjected to thermal oxidation treatment under specific conditions, the PPS resin can be made smaller in metal content and can be greatly decreased in volatile component without highly rising in melt viscosity.

Thermal oxidation treatment of a PPS resin has been performed since before. For example, JP 63-207827 A discloses an extruded article obtained by curing a PPS resin for keeping the polymer viscosity in a range from 5000 to 16000 poises (500 to 1600 Pa·s) (310° C., shear rate 200/sec) and for keeping the non-Newtonian coefficient n in a range from 1.5 to 2.1 and subsequently melt-extruding the cured resin. However, 5000 poises correspond to a melt flow rate of less than 100 g/10 min, and since the PPS resin is so high in melt viscosity as to considerably lower the flowability at the time of injection molding, the PPS resin is unsuitable for injection molding especially when it is a filler-containing PPS resin composition. Further, the PPS resin disclosed in JP '827 is relatively large in the degree of thermal oxidation treatment, and if the degree of thermal oxidation treatment is too large, the gas decreasing effect is saturated, and on the other hand, there is a problem that the melt flowability declines.

JP 6-248078 A discloses a method for treating a granular PPS resin with a weight average molecular weight of 30,000 or higher and an average particle size of 50 μm or smaller for thermal oxidation. However, as described in JP '078, for obtaining a PPS resin with a weight average molecular weight of 30,000 or higher and an average particle size of 50 μm or smaller, a special polymerization reactor or grinding is necessary to increase the cost, and therefore the method cannot be used as a general method. Further, such fine PPS particles cannot be smoothly fed into an extruder for melt kneading, to decrease the melt-kneaded and extruded amount per unit time uneconomically.

JP 1-121327 A discloses a method for curing a PPS resin in a low oxygen atmosphere, but does not refer to achieving both excellent melt flowability and low volatile component content by performing thermal oxidation treatment under specific conditions.

JP 2002-293934 A discloses a method comprising the steps of recovering a PPS resin by a flush method after polymerization, washing it with hot water of 130° C. or higher, filtering and treating with an acidic aqueous solution. This method can certainly decrease ionic impurities and the volatile component, but since dry PPS is treated at 180° C. for 4 hours in a nitrogen stream in the examples described in the document, the effect of decreasing the volatile component is small.

It could therefore be helpful to address the problem of obtaining a PPS resin excellent in melt flowability, small in metal content and in the amount of the volatile component generated during melting, and excellent in molding stability and wet heat resistance.

### SUMMARY

We discovered a process for producing a PPS resin remarkably decreased in the amount of the volatile component generated during melting, excellent in melt flowability and decreased in metal content to be excellent in molding stability and wet heat resistance, by relatively lightly treating an acid-treated PPS resin with a relatively low viscosity for thermal oxidation.

We provide:
1. A process for producing a polyphenylene sulfide resin with properties of (1) 0.3 wt % or less in the amount of the volatile gas generated when heated and melted at 320° C. in vacuum for 2 hours, (2) 0.3 wt % or less in the ash content achieved when incinerated at 550° C., (3) 4.0 wt % or less in the residue amount achieved when a solution with 1 part by weight of the polyphenylene sulfide resin dissolved in 20 parts by weight of 1-chloronaphthalene is pressure-filtered by a PTFE membrane filter with a pore size of 1 μm at 250° C. for 5 minutes, and (4) higher than 500 g/10 min in melt flow rate (according to ASTM D-1238-70: measured at a temperature of 315.5° C. and at a load of 5000 g), by acid-treating a polyphenylene sulfide resin in an acid treatment step and subsequently treating it for thermal oxidation in a thermal oxidation step.
2. A process for producing a polyphenylene sulfide resin, according to the abovementioned 1, wherein in the acid treatment step, the polyphenylene sulfide resin is immersed in an acid or an aqueous solution of the acid for treatment.
3. A process for producing a polyphenylene sulfide resin, according to the abovementioned 1 or 2, wherein in the acid treatment step, the polyphenylene sulfide resin is immersed in an acid or an aqueous solution of the acid for treatment at pH 2 to 8 and at 80 to 200° C.
4. A process for producing a PPS resin, according to any one of the abovementioned 1 through 3, wherein the step of treating the PPS resin by hot water at 80 to 200° C. is performed before the step of acid-treating the PPS resin.
5. A process for producing a PPS resin, according to any one of the abovementioned 1 through 4, wherein in the step of treating the PPS resin for thermal oxidation, the PPS resin is heat-treated in an atmosphere with an oxygen concentration of 2 vol % or more at 160 to 270° C. for 0.5 to 10 hours.
6. A process for producing a PPS resin, according to any one of the abovementioned 1 through 5, wherein the PPS resin is a resin recovered by a flush method.

We thus provide a PPS resin remarkably decreased in the amount of the volatile component generated during melting, excellent in melt flowability and further decreased in metal content to be excellent in molding stability and wet heat resistance.

### DETAILED DESCRIPTION

Selected modes for carrying out our processes are explained below in detail.

The PPS resin obtained by the production process is a polymer having the recurring units, each represented by the following structural formula (I):

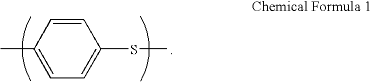

In view of heat resistance, it is preferred that the PPS resin contains 70% or more of a polymer having the recurring units, each represented by the abovementioned structural formula. More preferred is 90 mol % or more. Further, the PPS resin may contain less than about 30% of the recurring units represented by the following structures:

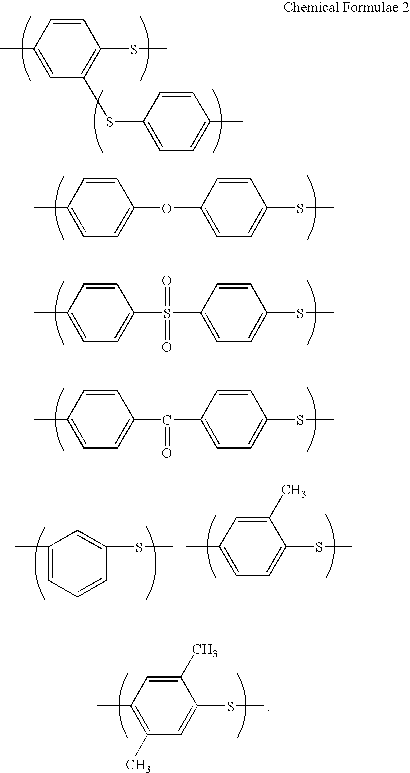

It is desirable that the PPS resin obtained by the production process is required to be (1) 0.3 wt % or less in the amount of the volatile gas generated when heated and melted at 320° C. in vacuum for 2 hours. Preferred is 0.28 wt % or less, and more preferred is 0.22 wt % or less. It is not preferred that the amount of the gas generated after thermal oxidation treatment is more than 0.3 wt %, since the volatile component deposited in the mold and in the old vent portion increases, and transfer failures and gas yellowing are likely to occur. The lower limit in the amount of the gas generated after thermal oxidation treatment is not especially limited, but it is uneconomical that the period of thermal oxidation treatment is long enough to decrease the gas generation amount, and further if the period of thermal oxidation treatment is too long, the gelation product is likely to be produced and molding failures may be caused.

Meanwhile, the gas generation amount means the amount of the gas volatilized by heating and melting the PPS resin in vacuum and later liquefied or solidified by cooling to be deposited. It can be measured by heating a glass ampoule hermetically containing the PPS resin in vacuum in a tubular furnace. The glass ampoule is shaped to have a belly portion of 100 mm×25 mm, a neck portion of 255 mm×12 mm and a wall thickness of 1 mm. As the particular measuring method, only the body portion of the glass ampoule hermetically containing the PPS resin in vacuum is inserted into a tubular furnace of 320° C. and heated for 2 hours, and the volatile gas is cooled and deposited in the neck portion of the ampoule which is not heated by the tubular furnace. The neck portion is cut out and weighed, and subsequently the deposited gas is dissolved into chloroform, for removal. Then the neck portion is dried and weighed again. From the difference between the weight of the neck portion of the ampoule before removing the gas and that after removing the gas, the gas generation amount can be obtained.

The PPS resin obtained by the production process is required to be (2) 0.3 wt % or less in the ash content achieved when incinerated at 550° C. Preferred is 0.2 wt % or less, and more preferred is 0.1 wt % or less. An ash content of more than 0.3 wt % means that the metal content of the PPS resin is large. A large metal content is not preferred for such reasons that the electric insulation becomes poor and that the decline of melt flowability and the decline of wet heat resistance can be caused.

The PPS resin obtained by the production process is required to be (3) 4.0 wt % or less in the residue amount achieved when a solution with 1 part by weight of the PPS resin dissolved in 20 parts by weight of 1-chloronaphthalene is pressure-filtered by a PTFE membrane filter with a pore size of 1 μm at 250° C. for 5 minutes. Preferred is 3.5 wt % or less, and more preferred is 3.0 wt % or less. A residue amount of more than 4.0 wt % means that the thermal oxidation crosslinking of the PPS resin has progressed excessively to increase the gelation product in the resin. It is not preferred that the thermal oxidation crosslinking of the PPS resin progresses excessively for such reasons that the effect of decreasing the volatile component is small and on the other hand that the decline of melt flowability and the production of a gelation product can cause molding failures. The lower limit of the residue amount is not especially limited, but is desirably 1.5% or more. Preferred is 1.7% or more. If the residue amount is smaller than 1.5%, the degree of thermal oxidation crosslinking is too low, and therefore the volatile component cannot be decreased so much during melting, the volatile component decrease effect being likely to remain small.

Meanwhile, the abovementioned residue amount is measured using a sample obtained by pressing a PPS resin to form a film with a thickness of about 80 μm, and using a high temperature filtration device and a SUS test tube equipped with a pneumatic cap and a gathering funnel. Particularly at first a membrane filter with a pore size of 1 μm is set in the SUS test tube, and 1 part by weight of the pressed film with a thickness of about 80 μm as a PPS resin and 20 parts by weight of 1-chloronaphthalene are weighed and sealed in the SUS test tube. The test tube is set in the high temperature filtration device of 250° C., and heated and shaken for 5 minutes. Then, an air-containing injector is connected with the pneumatic cap, and the piston of the injector is extruded for pneumatic filtration in the hot state. For particularly determining the residue amount, the membrane filter before filtration and the membrane filter dried at 150° C. for 1 hour after filtration are weighed, and from the difference of the weights, the residue amount is obtained.

The PPS resin obtained by the production process is required to be (4) higher than 500 g/10 min in melt flow rate (according to ASTM D-1238-70: measured at a temperature of 315.5° C. and at a load of 5000 g). It is not preferred that the melt flow rate is 500 g/10 min or lower, since in the case where the PPS resin filled with a large amount of a filler is used, the melt flowability of the PPS resin composition becomes so low as to destabilize the molding. The upper limit of the melt viscosity of the PPS resin obtained by the production process is not especially limited, but with view to obtaining a resin (composition) with a strength enduring practical use, 1 Pa·s (300° C., shear rate 1000/sec) or more is preferred.

The PPS resin obtained by the production process is required to satisfy all the abovementioned properties (1) through (4).

A PPS resin is subjected to acid treatment and subsequently to thermal oxidation treatment for obtaining a PPS resin with the specific properties. The PPS resin to be subjected to the acid treatment and the thermal oxidation treatment, respectively, can be a PPS resin obtained by any method. Therefore, a commercially available PPS resin can also be used, and a PPS resin produced by polymerizing monomers as described below can also be used.

The method for producing a PPS resin to be subjected to the acid treatment and the thermal oxidation treatment, respectively, is described below. At first, the polyhalogenated aromatic compound, sulfidizing agent, polymerization solvent, molecular weight modifier, polymerization aid and polymerization stabilizer will be explained below.

### Polyhalogenated Aromatic Compound

A polyhalogenated aromatic compound refers to a compound having two or more halogen atoms per one molecule. Examples of the polyhalogenated aromatic compound include p-dichlorobenzene, m-dichlorobenzene, o-dichlorobenzene, 1,3,5-trichlorobenzene, 1,2,4-trichlorobenzene, 1,2,4,5-tetrachlorobenzene, hexachlorobenzene, 2,5-dichlorotoluene, 2,5-dichloro-p-xylene, 1,4-dibromobenzene, 1,4-diiodobenzene, 1-methoxy-2,5-dichlorobenzene and the like. Preferably p-dichlorobenzene can be used. Further, a copolymer obtained by combining two or more different polyhalogenated aromatic compounds can also be used, but it is preferred that a p-dihalogenated aromatic compound is a major component.

The amount of the polyhalogenated aromatic compound used is in a range from 0.9 to 2.0 moles per 1 mole of the sulfidizing agent for obtaining a PPS resin with a viscosity suitably for processing. A preferred range is 0.95 to 1.5 moles, and a more preferred range is 1.05 to 1.2 moles.

### Sulfidizing Agent

The sulfidizing agent can be an alkali metal sulfide, alkali metal hydrosulfide or hydrogen sulfide.

Examples of the alkali metal sulfide include lithium sulfide, sodium sulfide, potassium sulfide, rubidium sulfide, cesium sulfide and a mixture consisting of two or more of the foregoing, and among them, sodium sulfide can be preferably used. Any of these alkali metal sulfides can be used as a hydrate or aqueous mixture or anhydride.

Examples of the alkali metal hydrosulfide include sodium hydrosulfide, potassium hydrosulfide, lithium hydrosulfide, rubidium hydrosulfide, cesium hydrosulfide and a mixture consisting of two or more of the foregoing, and among them, sodium hydrosulfide can be preferably used. Any of these alkali metal hydrosulfides can be used as a hydrate or aqueous mixture or anhydride.

Further, a sulfidizing agent prepared from an alkali metal hydrosulfide and an alkali metal hydroxide in situ in a reaction system can also be used. Further, the sulfidizing agent prepared from an alkali metal hydrosulfide and an alkali metal hydroxide can also be transferred for use in a polymerization vessel.

Furthermore, a sulfidizing agent prepared from an alkali metal hydroxide such as lithium hydroxide or sodium hydroxide and hydrogen sulfide in situ in a reaction system can also be used. Moreover, the sulfidizing agent prepared from an alkali metal hydroxide such as lithium hydroxide or sodium hydroxide and hydrogen sulfide can also be transferred for use in a polymerization vessel.

In the case where the sulfidizing agent is partially lost due to dehydration operation or the like before initiation of polymerization reaction, the supplied amount of the sulfidizing agent means the remaining amount obtained by subtracting the loss from the actually supplied amount.

Meanwhile, an alkali metal hydroxide and/or an alkaline earth metal hydroxide can also be used together with the sulfidizing agent. Preferred examples of the alkali metal hydroxide include sodium hydroxide, potassium hydroxide, lithium hydroxide, rubidium hydroxide, cesium hydroxide and a mixture consisting of two or more of the foregoing, and preferred examples of the alkaline earth metal hydroxide include calcium hydroxide, strontium hydroxide, barium hydroxide and the like. Among them, sodium hydroxide can be preferably used.

In the case where an alkali metal hydrosulfide is used as the sulfidizing agent, it is especially preferred to use an alkali metal hydroxide simultaneously, and the amount of the alkali metal hydroxide used is in a range from 0.95 to 1.20 moles per 1 mole of the alkali metal hydrosulfide. A preferred range is 1.00 to 1.15 moles, and a more preferred range is 1.005 to 1.100 moles.

### Polymerization Solvent

It is preferred to use an organic polar solvent as the polymerization solvent. Examples of the organic polar solvent include aprotic organic solvents typified by N-alkylpyrrolidones such as N-methyl-2-pyrrolidone and N-ethyl-2-pyrrolidone, caprolactams such as N-methyl-ε-caprolactam, 1,3-dimethyl-2-imidazolidinone, N,N-dimethylacetamide, N,N-dimethylformamide, hexamethyl phosphoric acid triamide, dimethylsulfone, tetramethylene sulfoxide, mixtures thereof or the like. Any of these solvents can be preferably used since they are high in reaction stability. Among them, especially N-methyl-2-pyrrolidone (hereinafter may be abbreviated as NMP) can be preferably used.

The amount of the organic polar solvent used is selected in a range from 2.0 moles to 10 moles per 1 mole of the sulfidizing agent. A preferred range is 2.25 to 6.0 moles, and a more preferred range is 2.5 to 5.5 moles.

### Molecular Weight Modifier

For forming the ends of a produced PPS resin or for adjusting the polymerization reaction or the molecular weight, a monohalogen compound (not necessarily required to be an aromatic compound) can also be used together with the abovementioned polyhalogenated aromatic compound.

### Polymerization Aid

Using a polymerization aid for obtaining a PPS resin with a relatively high polymerization degree in a shorter period of time is one of preferred modes. In this case, the polymerization aid means a substance that can act to increase the viscosity of the PPS resin obtained. Examples of the polymerization aid include an organic carboxylate, water, alkali metal chloride, organic sulfonate, sulfuric acid alkali metal salt, alkaline earth metal oxide, alkali metal phosphate, alkaline earth metal phosphate and the like. Any one of them can be used alone or two or more of them can also be used together. Among them, an organic carboxylate and/or water can be preferably used.

The abovementioned alkali metal carboxylate is a compound represented by general formula R(COOM)ₙ (where R denotes an alkyl group, cycloalkyl group, aryl group, alkylaryl group or arylalkyl group respectively having 1 to 20 carbon atoms; M denotes an alkali metal selected from lithium, sodium, potassium, rubidium and cesium; and n denotes an integer of 1 to 3). The alkali metal carboxylate can also be used as a hydrate, anhydride or aqueous solution. Particular examples of the alkali metal carboxylate include lithium acetate, sodium acetate, potassium acetate, sodium propionate, lithium valerate, sodium benzoate, sodium phenylacetate, potassium p-toluoylate, mixtures thereof or the like.

An alkali metal carboxylate can also be formed by adding almost equal chemical equivalents of an organic acid and one or more compounds selected from the group consisting of alkali metal hydroxides, alkali metal carbonates and alkali metal bicarbonates to each other for reaction. Among the abovementioned alkali metal carboxylates, a lithium salt is highly dissolvable in the reaction system, having a high aid effect but is expensive, and a potassium salt, rubidium salt or cesium salt is considered to be insufficiently dissolvable in the reaction system. Therefore, sodium acetate inexpensive and moderately dissolvable in the polymerization system can be most preferably used.

The amount of the polymerization aid, if used, is usually in a range from 0.01 mole to 0.7 mole per 1 mole of the supplied alkali metal sulfide. A preferred range for obtaining a higher polymerization degree is 0.1 to 0.6 mole, and a more preferred range is 0.2 to 0.5 mole.

Using water as a polymerization aid is one of effective means for obtaining a resin composition highly balanced between flowability and high toughness. In this case, the added amount is usually in a range from 0.5 mole to 15 moles per 1 mile of the supplied alkali metal sulfide. A preferred range for obtaining a higher polymerization degree is 0.6 to 10 moles, and a more preferred range is 1 to 5 moles.

The time when the polymerization aid is added is not especially specified, and the polymerization aid can be added at any time during the preliminary step described later, at the time of initiating the polymerization or during the polymerization, and can also be added partially multiple times. However, in the case where an alkali metal carboxylate is used as the polymerization aid, in view of easy addition, it is preferred to add it at a time at the time of initiating the preliminary step or at the time of initiation the polymerization. Further, in the case where water is used as the polymerization aid, adding during the polymerization reaction after supplying the polyhalogenated aromatic compound is effective.

### Polymerization Stabilizer

A polymerization stabilizer can be used for stabilizing the polymerization reaction system and for preventing side reactions. A polymerization stabilizer contributes to the stabilization of the polymerization reaction system and to the inhibition of unwanted side reactions. One of the side reactions is the production of thiophenol, and if a polymerization stabilizer is added, the production of thiophenol can be inhibited. Examples of the polymerization stabilizer include such compounds as alkali metal hydroxides, alkali metal carbonates, alkaline earth metal hydroxides and alkaline earth metal carbonates. Among them, alkali metal hydroxides such as sodium hydroxide, potassium hydroxide and lithium hydroxide are preferred. The abovementioned alkali metal carboxylates also act as polymerization stabilizers, and therefore are included in the polymerization stabilizers. Further, in the case where an alkali metal hydrosulfide is used as the sulfidizing agent, as described before, it is especially preferred to use an alkali metal hydroxide simultaneously. The alkali metal hydroxide that is added by an amount excessive for the sulfidizing agent can also act as a polymerization stabilizer.

Any one of these polymerization stabilizers can be used alone or two or more of them can also be used in combination. The amount of the polymerization stabilizer is usually in a range from 0.02 to 0.2 mole per 1 mole of the supplied alkali metal sulfide. A preferred range is 0.03 to 0.1 mole, and a more preferred range is 0.04 to 0.09 mole. If the amount is too small, the stabilization effect is insufficient, and if the amount is too large on the contrary, an economical disadvantage occurs while the polymer yield tends to decline.

The time when the polymerization stabilizer is added is not especially specified and can be added at any time during the preliminary step described later, at the time of initiating the polymerization or during the polymerization, and can also be added partially multiple times. However, in view of easy addition, it is preferred to add at a time at the time of initiating the preliminary step or at the time of initiating the polymerization.

The preliminary step, polymerization reaction step and recovery step will be particularly explained below in this order.

### Preliminary Step

The sulfidizing agent is usually used as a hydrate, and it is preferred to heat a mixture containing an organic polar solvent and the sulfidizing agent before adding the polyhalogenated aromatic compound, for removing the excessive amount of water outside the system. Meanwhile, in the case where water is removed excessively by this operation, it is preferred to add water for covering the shortage.

Further, as described above, as the sulfidizing agent, the alkali metal sulfide prepared from an alkali metal hydrosulfide and an alkali metal hydroxide in situ in a reaction system or in a vessel other than a polymerization vessel can also be used. The method is not especially limited, but used is a method comprising the steps of adding an alkali metal hydrosulfide and an alkali metal hydroxide to an organic polar solvent desirably in an inert gas atmosphere in a temperature range from room temperature to 150° C., preferably room temperature to 100° C., and heating at normal pressure or under reduced pressure to at least 150° C. or higher, preferably to a range from 180 to 260° C., for distilling away water. At this stage, a polymerization aid can also be added. Further, to promote the removal of water by distillation, toluene or the like can also be added for performing the reaction.

In the polymerization reaction, it is preferred that the amount of water in the polymerization system is 0.5 to 10.0 moles per 1 mole of the supplied sulfidizing agent. In this case, the amount of water in the polymerization system is the amount obtained by subtracting the amount of water removed outside the polymerization system from the amount of water supplied into the polymerization system. Further, the supplied water can be any of water, aqueous solution, crystal water or the like.

### Polymerization Reaction Step

It is preferred that a sulfidizing agent and a polyhalogenated aromatic compound are made to react with each other in an organic polar solvent in a temperature range from 200° C. to lower than 290° C., for producing PPS resin particles.

When the polymerization reaction step is initiated, the sulfidizing agent and the polyhalogenated aromatic compound are added to the organic polar solvent desirably in an inert gas atmosphere in a temperature range from room temperature to 220° C., preferably 100 to 220° C. At this stage, a polymerization aid can also be added. The order for supplying these raw materials is not established and the raw materials can also be added simultaneously.

The mixture is usually heated to a range from 200° C. to 290° C. The heating rate is not especially limited, but usually selected in a range from 0.01 to 5° C./min, and a preferred range is 0.1 to 3° C./min.

In general, the mixture is heated finally to a temperature of 250 to 290° C., and is made to react usually at the temperature usually for 0.25 to 50 hours, preferably 0.5 to 20 hours.

A method of performing the reaction, for example, at 200° C. to 260° C. for a certain period of time in the stage before the final temperature is reached, and subsequently heating to a range from 270 to 290° C. is effective for obtaining a higher polymerization degree. In this case, the reaction time at 200° C. to 260° C. is usually selected in a range from 0.25 hour to 20 hours, preferably in a range from 0.25 to 10 hours.

Meanwhile, for obtaining a polymer with a higher polymerization degree, performing the polymerization in multiple stages is effective. For performing the polymerization in multiple stages, it is effective that the conversion of the polyhalogenated aromatic compound in the system reaches 40 mol % or higher, preferably 60 mol % at 245° C.

### Recovery Step

After completion of polymerization, a solid material is recovered from a polymerization reaction product containing the polymer, solvent and the like.

The most preferred methods for recovering the PPS resin include methods of recovering under a quickly cooling condition, and one of the most preferred recovering methods is a flush method. In a flush method, the polymerization reaction product is flushed from the state of high temperature and high pressure (usually higher than 250° C. and higher than 8 kg/cm²) into an atmosphere of normal pressure or reduced pressure, for recovering the polymer as particles while recovering the solvent. The flushing in this method means to spout the polymerization reaction product from a nozzle. The atmosphere into which the polymerization reaction product is flushed is particularly, for example, nitrogen or water vapor of normal pressure, and the temperature is usually selected in a range from 150° C. to 250° C.

According to a flush method, the solid material can be recovered simultaneously with the recovery of the solvent, and the recovery time can also be relatively short. Therefore, a flush method is an economically excellent recovery method. In the recovery method, an ionic compound typified by sodium and an organic low polymerization product (oligomer) tend to be incorporated into the polymer in the process of solidification.

However, the method for recovering the PPS resin used in the production process is not limited to a flush method. A method of recovering the polymer particles by slow cooling (quenching method) can also be used if the method satisfies the requirements. However, in view of economic efficiency and performance, it is more preferred to use the PPS resin recovered by a flush method for the production process.

The acid treatment and the thermal oxidation treatment of a PPS resin as essential requirements will be described below in detail.

In the PPS resin production process, it is essential that the PPS resin obtained, for example, by the abovementioned polymerization reaction step and recovery step is acid-treated in the acid treatment step, and it is preferred that a hot water treatment step is performed before acid treatment step. Further, a step of washing by an organic solvent may also be performed before the acid treatment step and the hot water treatment step.

The acid used in the acid treatment is not especially limited, if it does not act to decompose the PPS resin, and the examples of the acid include acetic acid, hydrochloric acid, sulfuric acid, phosphoric acid, silicic acid, carbonic acid, propionic acid and the like. Among them, acetic acid and hydrochloric acid can be more preferably used, but an acid that decomposes or deteriorates the PPS resin, such as nitric acid, is not preferred.

When an aqueous solution of an acid is used, it is preferred that the water is either distilled water or deionized water. It is preferred that the pH of the acid aqueous solution is 1 to 7, and a more preferred range is 2 to 4. It is not preferred that pH is 7 or larger, since the metal content of the PPS resin increases. It is not preferred either that pH is smaller than 1, since the volatile component of the PPS resin increases.

As the acid treatment method, it is preferred to immerse the PPS resin in an acid or an aqueous solution of the acid, and as required, stirring and heating can also be performed. When heating is performed, it is preferred that the temperature is 80 to 250° C. A more preferred range is 120 to 200° C., and a further more preferred range is 150 to 200° C. It is not preferred that the temperature is lower than 80° C. for such reasons that the acid treatment effect is small and that the metal content increases, and it is not preferred either in view of safety that the temperature is higher than 250° C., since the pressure becomes too high. Further, when the PPS resin is immersed in an aqueous solution of an acid for treatment, it is preferred that the pH achieved by the acid treatment is lower than 8, and a pH range from 2 to 8 is more preferred. It is not preferred that pH is larger than 8, since the metal content of the PPS resin increases.

It is preferred that the acid treatment time for the reaction between the PPS resin and the acid to reach satisfactory equilibrium is 2 to 24 hours in the case where the treatment is performed at 80° C., and it is preferred that the time is 0.01 to 5 hours in the case where the treatment is performed at 200° C.

As for the ratio between the PPS resin and the acid or the acid aqueous solution in the acid treatment, since it is preferred to keep the PPS resin sufficiently immersed in the acid or in the acid aqueous solution during the treatment, it is preferred to use 0.5 to 500 L of the acid or acid aqueous solution per 500 g of the PPS resin. A more preferred range is 1 to 100 L, and a further more preferred range is 2.5 to 20 L. It is not preferred that the amount of the acid or acid aqueous solution is smaller than 0.5 L per 500 g of the PPS resin, since the PPS resin cannot be sufficiently immersed in the aqueous solution, being only insufficiently washed to be larger in metal content. Further, it is not preferred either that the amount of the acid or acid aqueous solution is more than 500 L per 500 g of the PPS resin, since the amount of the solution becomes so large for the amount of the PPS resin that the production efficiency declines remarkably.

The acid treatment is performed by a method of supplying a predetermined amount of the PPS resin into predetermined amounts of water and the acid and heating/stirring in a pressure vessel, or a method of continuously performing the acid treatment or the like. As the method for separating the aqueous solution and the PPS resin from the treatment solution after completion of the acid treatment, filtration using a sieve or filter is simple and, for example, natural filtration, pressurized filtration, reduced pressure filtration, centrifugal separation or the like can be used. For removing the acid and impurities remaining on the surface of the PPS resin separated from the treatment solution, it is preferred to wash with cold or hot water several times. The washing method can be a method of watering the PPS resin on a filtration device while filtering, or a method of supplying the separated PPS resin into prearranged water and filtering again, for separating the aqueous solution and the PPS resin. It is preferred that the water used for washing is either distilled water or deionized water.

It is preferred to perform hot water treatment by the following method before the acid treatment step. It is preferred that the water used for the hot water treatment is either distilled water or deionized water. It is preferred that the hot water treatment temperature is 80 to 250° C. A more preferred range is 120 to 200° C., and a further more preferred range is 150 to 200° C. It is not preferred that the temperature is lower than 80° C. for such reasons that the hot water treatment effect is small and that the volatile gas generation amount increases, and it is not preferred either in view of safety that the temperature is higher than 250° C. since the pressure becomes too high.

It is preferred that the hot water treatment time is long enough to allow the sufficient extraction treatment by the PPS resin and hot water. A preferred range of the treatment time at 80° C. is 2 to 24 hours, and a preferred range of the treatment time at 200° C. is 0.01 to 5 hours.

It is preferred that the ratio between the PPS resin and water in the hot water treatment is such as to allow treatment in the state where the PPS resin is sufficiently kept immersed in water. It is preferred that the amount of water per 500 g of the PPS resin is 0.5 to 500 L. A more preferred range is 1 to 100 L, and a further more preferred range is 2.5 to 20 L. It is not preferred that the amount of water is smaller than 0.5 L per 500 g of the PPS resin for such reasons that the PPS resin cannot be sufficiently kept immersed in water, being only insufficiently washed and that the volatile gas generation amount increases. Further, it is not preferred either that the amount of water is more than 500 L per 500 g of the PPS resin, since the amount of water becomes so large for the amount of the PPS resin that the production efficiency declines remarkably.

The operation of the hot water treatment is not especially limited, and a method of supplying a predetermined amount of the PPS resin into a predetermined amount of water and heating/stirring in a pressure vessel, or a method of continuously performing the hot water treatment or the like can be used. The method of separating the aqueous solution and the PPS resin from the treatment solution after completion of the hot water treatment is not especially limited, but filtration using a sieve or a filter is simple and, for example, natural filtration, pressurized filtration, reduced pressure filtration, centrifugal filtration or the like can be used. For removing the impurities remaining on the surface of the PPS resin separated from the treatment solution, it is preferred to wash with cold or hot water several times. The washing method is not especially limited, and can be a method of watering the PPS resin on a filtration device while filtering, or a method of supplying the separated PPS resin into prearranged water and filtering again, for separating the aqueous solution and the PPS resin. It is preferred that the water used for washing is either distilled water or deionized water.

Further, since the decomposition of PPS end groups during the acid treatment and during the hot water treatment is not preferred, it is desirable to perform the acid treatment and the hot water treatment in an inert atmosphere. The inert atmosphere can be nitrogen, helium, argon or the like, but a nitrogen atmosphere is preferred from an economical viewpoint.

Before the acid treatment step and the hot water treatment step, a step of washing with an organic solvent can also be used. The method is as described below. The organic solvent used for washing the PPS resin is not especially limited if it does not act to decompose the PPS resin. Examples of the organic solvent include nitrogen-containing polar solvents such as N-methyl-2-pyrrolidone, dimethylformamide, dimethylacetamide, 1,3-dimethylimidazolidinone, hexamethyl phosphorus amide and piperazinones, sulfoxide/sulfone-based solvents such as dimethyl sulfoxide, dimethylsulfone and sulfolane, ketone-based solvents such as acetone, methyl ethyl ketone, diethyl ketone and acetophenone, ether-based solvents such as dimethyl ether, dipropyl ether, dioxane and tetrahydrofuran, halogen-based solvents such as chloroform, methylene chloride, trichloroethylene, ethylene dichloride, perchloroethylene, monochloroethane, dichloroethane, tetrachloroethane, perchloroethane and chlorobenzene, alcohol/phenol-based solvents such as methanol, ethanol, propanol, butanol, pentanol, ethylene glycol, propylene glycol, phenol, cresol, polyethylene glycol and polypropylene glycol, aromatic hydrocarbon-based solvents such as benzene, toluene, xylene and the like. Among these organic solvents, it is especially preferred to use N-methyl-2-pyrrolidone, acetone, dimethylformamide, chloroform or the like. Any one of these organic solvents can be used alone or two or more of them can also be used as a mixture.

The method for washing with an organic solvent can be, for example, a method of immersing the PPS resin into the organic solvent, and as required, stirring or heating can also be performed. The washing temperature for washing the PPS resin with the organic solvent is not especially limited and an arbitrary temperature can be selected in a range from room temperature to about 300° C. If the washing temperature is higher, the washing efficiency tends to be higher, and usually a sufficient effect can be obtained at a washing temperature of room temperature to 150° C. The washing can also be performed in a pressure vessel under pressurization at a temperature higher than the boiling point of the organic solvent. Further, the washing time is not especially limited either. In the case of batch washing, though depending on the washing conditions, usually a sufficient effect can be obtained by washing for 5 minutes or more. Continuous washing can also be performed.

The acid treatment, the hot water treatment and the washing with an organic solvent can also be appropriately combined.

We found that only if a PPS resin is acid-treated before it is subjected to the thermal oxidation treatment, a PPS resin excellent in melt flowability, small in metal content and in the amount of the volatile component generated during melting and excellent in molding stability and wet heat resistance can be obtained. Unless the PPS resin is acid-treated before it is subjected to the thermal oxidation treatment, both excellent melt flowability and the inhibition of the volatile component during melting cannot be achieved, and as a result, a PPS resin excellent in moldability and wet heat resistance cannot be obtained.

In the PPS resin production process, the abovementioned acid treatment and hot water treatment or washing with an organic solvent are followed by the thermal oxidation treatment. The thermal oxidation treatment refers to the treatment performed by heating the PPS resin in an oxygen atmosphere or by adding a peroxide such as H₂O₂ or a sulfurizing agent such as S to the PPS resin and subsequently heating, and in view of treatment simplicity, heating in an oxygen atmosphere is especially preferred.

The heater used for the thermal oxidation treatment can be an ordinary hot air dryer, rotary heater or heater with stirring blades, but in the case where an efficient and homogeneous treatment is intended, it is more preferred to use a rotary heater or heater with stirring blades. It is desirable that the oxygen concentration in the atmosphere of the thermal oxidation treatment is 2 vol % or higher. More desirable is 8 vol % or higher. The upper limit of the oxygen concentration is not especially limited, but in view of safe operation, about 50 vol % is the limit, and more preferred is 25 vol % or lower. It is preferred that the thermal oxidation treatment temperature is 160 to 270° C. A more preferred range is 160 to 220° C. It is not preferred that the thermal oxidation treatment is performed at a temperature higher than 270° C. for such reasons that the thermal oxidation treatment progresses so rapidly as to make the control difficult and that flowability remarkably declines. On the other hand, it is not preferred either that the temperature is lower than 160° C. for such reasons that the thermal oxidation treatment progresses very slowly and that the generated amount of the volatile component increases. It is preferred that the treatment time is 0.2 to 50 hours. A more preferred range is 0.5 to 10 hours, and a further more preferred range is 1 to 5 hours. It is not preferred that the treatment time is shorter than 0.2 hour for such reasons that the thermal oxidation treatment cannot be performed sufficiently and that the amount of the volatile component is too large. It is not preferred either that the treatment time is longer than 50 hours for such reasons that the crosslinking reaction by the thermal oxidation treatment progresses to lower the flowability and that the residue amount achieved when a solution with 1 part by weight of the PPS resin dissolved in 20 parts by weight of 1-chloronaphthalene is pressure-filtered by a PTFE membrane filter with a pore size of 1 μm at 250° C. for 5 minutes increases to lower the molding stability.

Further, dry heat treatment can also be performed before and after the thermal oxidation treatment, for the purposes of inhibiting the thermal oxidation crosslinking and removing water. It is preferred that the temperature is 100 to 270° C., and a more preferred range is 120 to 200° C. Further, it is desirable that the oxygen concentration in this case is lower than 2 vol %. It is preferred that the treatment time is 0.2 to 50 hours. A more preferred range is 0.5 to 10 hours, and a further more preferred range is 1 to 5 hours. The heat treatment device can be an ordinary hot air dryer or rotary heater or heater with stirring blades, but in the case where an efficient and more homogeneous treatment is intended, it is more preferred to use a rotary heater or heater with stirring blades.

The PPS resin obtained by the production process as described above is excellent in heat resistance, chemicals resistance, flame retardancy, electric properties and mechanical properties and can be applied as injection molded articles, films, sheets, fibers and the like, being able to be especially suitably applied for injection molding.

Meanwhile, it is most preferred to obtain a molded article by using only the PPS resin obtained by the production process, but as required, it is permitted to blend a PPS resin not in conformity with the abovementioned conditions. As the blending rate, the PPS resin obtained by the production process can be blended by 75 to 25% (for example, 75%, 50%, 25%) selected as required.

Further, another resin can also be added to the PPS resin obtained by the production process to such an effect that the effects are not impaired. For example, if a small amount of a highly soft thermoplastic resin is added, flexibility and impact resistance can be further enhanced. However, it is not preferred that the amount of the thermoplastic resin exceeds 50 wt % of the entire composition, since the features peculiar to the PPS resin will be impaired. Especially adding 30 wt % or less is preferred. Examples of the thermoplastic resin include epoxy group-containing olefin-based copolymers, other olefin-based resins, polyamide resins, polybutylene terephthalate resins, polyethylene terephthalate resins, polyphenylene ether resins, polysulfone resins, polyallylsulfone resins, polyketone resins, polyetherimide resins, polyarylate resins, liquid crystal polymers, polyether sulfone resins, polyether ketone resins, polythioether ketone resins, polyetherether ketone resins, polyimide resins, polyamideimide resins, polyethylene tetrafluoride resins and the like.

Further, for the purpose of modification, any of the following compounds can be added: ordinary additives, for example, coupling agents such as isocyanate-based compounds, organic silane-based compounds, organic titanate-based compounds, organic borane-based compounds and epoxy compounds, plasticizers such as polyalkylene oxide oligomer-based compounds, thioether-based compounds, ester-based compounds and organic phosphorus-based compounds, crystal nucleating agents such as talc, kaolin, organic phosphorus compounds and polyethyether ketones, metallic soaps such as montanic acid waxes, lithium stearate and aluminum stearate, releasing agents such as ethylenediamine-stearic acid-sebacic acid polycondensation product and silicone-based compounds, coloration preventives such as hypophosphites, further lubricants, ultraviolet light protective agents, colorants, foaming agents and the like. It is not preferred that the amount of any of the abovementioned compounds exceeds 20 wt % of the entire composition, since the properties peculiar to the PPS resin will be impaired. Adding 10 wt % or less, preferably 1 wt % or less is desirable.

Further, for the purpose of enhancing the mechanical strength, toughness and the like, an alkoxysilane having at least one type of functional groups selected from epoxy groups, amino groups, isocyanate groups, hydroxyl groups, mercapto groups and ureido groups can also be added to the PPS resin obtained by the production process. Examples of the compound include epoxy group-containing alkoxysilane compounds such as γ-glycidoxypropyltrimethoxysilane, γ-glycidoxypropyltriethoxysilane and β-(3,4-epoxycyclohexyl)ethyltrimethoxysilane, mercapto group-containing alkoxysilane compounds such as γ-mercaptopropyltrimethoxysilane and γ-mercaptopropyltriethoxysilane, ureido group-containing alkoxysilane compounds such as γ-ureidopropyltriethoxysilane, γ-ureidopropyltrimethoxysilane and γ-(2-ureidoethyl)aminopropyltrimethoxysilane, isocyanato group-containing alkoxysilane compounds such as γ-isocyanatopropyltriethoxysilane, γ-isocyanatopropyltrimethoxysilane, γ-isocyanatopropylmethyldimethoxysilane, γ-isocyanatopropylmethyldiethoxysilane, γ-isocyanatopropylethyldimethoxysilane, γ-isocyanatopropylethyldiethoxysilane and γ-isocyanatopropyltrichlorosilane, amino group-containing alkoxysilane compounds such as γ-(2-aminoethyl)aminopropylmethyldimethoxysilane, γ-(2-aminoethyl)aminopropyltrimethoxysilane and γ-aminopropyltrimethoxysilane, hydroxyl group-containing alkoxysilane compounds such as γ-hydroxypropyltrimethoxysilane and γ-hydroxypropyltriethoxysilane and the like.

The suitably added amount of the silane compound is selected in a range from 0.05 to 5 parts by weight per 100 parts by weight of the PPS resin.

A filler can also be mixed with the PPS resin obtained by the production process to such an extent that the effects are not impaired. Examples of the filler include fibrous fillers such as glass fibers, carbon fibers, basalt fibers, potassium titanate whiskers, zinc oxide whiskers, calcium carbonate whiskers, wollastonite whiskers, aluminum borate whiskers, aramid fibers, alumina fibers, silicon carbide fibers, ceramic fibers, asbestos fibers, gypsum fibers and metallic fibers, silicates such as talc, wollastonite, zeolite, sericite, mica, kaolin, clay, pyrophyllite, bentonite, asbestos and alumina silicate, metal compounds such as silicon oxide, magnesium oxide, alumina, zirconium oxide, titanium oxide and iron oxide, carbonates such as calcium carbonate, magnesium carbonate and dolomite, sulfates such as calcium sulfate and barium sulfate, hydroxides such as calcium hydroxide, magnesium hydroxide and aluminum hydroxide, non-fibrous fillers such as glass beads, glass flakes, glass powder, ceramic beads, carbon nanotubes, fullerenes, boron nitride, silicon carbide, carbon black, silica and graphite. The filler can also be hollow, and two or more types of these fillers can also be used together. Further, any of these fillers can also be treated preliminarily with a coupling agent such as an isocyanate-based compound, organic silane-based compound, organic titanate-based compound, organic borane-based compound or epoxy compound.

It is preferred that the mixed amount of any of these inorganic fillers is usually 0.0001 to 500 parts by weight per 100 parts by weight of the PPS resin. A more preferred range is 0.001 to 400 parts by weight. The inorganic filler content can be changed as appropriate for respective applications in view of the balance among strength, stiffness and other properties.

Usually typically the PPS resin is supplied into a publicly known melt kneader such as a single-screw extruder, twin-screw extruder, Banbury mixer, kneader or mixing roll mill and kneaded with the melt peak temperature of the PPS resin+5 to 60° C. as the processing temperature. In the case where subsidiary raw materials are used, the mixing order of raw materials is not especially limited, and usable is any method such as a method comprising the steps of mixing all the raw materials and melt-kneading the mixture by the abovementioned kneading method, a method comprising the steps of mixing some of the raw materials, melt-kneading the mixture by the abovementioned kneading method, and further mixing the other raw materials for subsequent melt-kneading, or a method of mixing some of the raw materials, and melt-kneading the mixture using a single-screw or twin-screw extruder, while mixing the other raw materials using the side feeder. Moreover, the ingredients to be added by small amounts can of course be added after the other ingredients are kneaded by the abovementioned method and pelletized, so that the entire composition thus obtained can be molded.

The PPS resin (composition) obtained as described above is suitable especially for injection molding. Particular applications of the PPS resin include, for example, electric/electronic parts such as sensors, LED lamps, connectors, sockets, resistors, relay cases, switches, coil bobbins, capacitors, variable capacitor cases, optical pickups, vibrators, various terminal boards, transformers, plugs, printed circuit boards, tuners, speakers, microphones, headphones, small motors, magnetic head bases, power modules, encapsulated semiconductor parts, liquid crystal display parts, FDD carriages, FDD chassis, motor brush holders, parabolic antennas and computer-related parts; household and office electric appliance parts such as VTR parts, television parts, irons, hair dryers, rice cooker parts, electronic oven parts, audio apparatus parts including audio parts, audio laser discs and compact discs, illumination parts, refrigerator parts, air conditioner parts, typewriter parts and word processor parts; machine-related parts such as office computer-related parts, telephone-related parts, facsimile-related parts, copier-related parts, washing fixtures, motor parts, lighters and typewriters; optical devices and precision machine-related parts such as microscopes, binoculars, cameras and timepieces; water service parts such as tap plugs, water mixing faucets, pump parts, pipe joints, water quantity control valves, relief valves, water temperature sensors, water quantity sensors and water line meter housings; automobile/vehicle-related parts such as valve alternator terminals, alternator connectors, IC regulators, potentiometer bases for light dimmers, various valves including exhaust gas valves, various pipes for fuel and suction and discharge systems, air intake nozzle snorkels, intake manifolds, fuel pumps, engine cooling water joints, carburetor main bodies, carburetor spacers, exhaust gas sensors, cooling water sensors, oil temperature sensors, throttle position sensors, crankshaft position sensors, air flow meters, brake pad wear sensors, air conditioner thermostat bases, room hot air flow control valves, radiator motor brush holders, water pump impellers, turbine vanes, wiper motor-related parts, distributors, starter switches, starter relays, transmission wire harnesses, window washer nozzles, air conditioner panel switch boards, fuel-related electromagnetic valve coils, fuse connectors, horn terminals, electric equipment part insulation boards, step motor rotors, lamp sockets, lamp reflectors, lamp housings, brake pistons, solenoid bobbins, engine oil filters, ignition device cases, car speed sensors, cable liners, engine control unit cases, engine driver unit cases, capacitor cases, motor insulation materials and hybrid car control system parts, and other various applications.

### EXAMPLES

Our processes are explained below more particularly in reference to examples, but is not limited thereto or thereby.

In the following examples, material properties were evaluated by the following methods.

### Gas Generation Amount

Three grams of a PPS resin was weighed and placed in a glass ampoule having a belly portion of 100 mm×25 mm, a neck portion of 255 mm×12 mm and a wall thickness of 1 mm, and the ampoule was sealed in vacuum. The body portion only of the glass ampoule was inserted into ceramic electric tubular furnace ARF-30K produced by K.K. Asahi Rika Seisakusho and heated at 320° C. for 2 hours. The ampoule was taken out, and the neck portion of the ampoule, which was not heated by the tubular furnace and had a volatile gas deposited therein was cut out using a file and weighed. Subsequently, the deposited gas was dissolved by 5 g of chloroform and removed, and the neck portion was dried by a glass dryer of 60° C. for 1 hour and weighed again. The difference between the weight of the neck portion of the ampoule before gas removal and that after gas removal was calculated as the gas generation amount (wt %).

### Ash Content

Accurately weighed 5 g of a sample was placed in a crucible baked at 550° C. beforehand, and the crucible was placed in an electric furnace of 550° C. for 24 hours, for incinerating the sample. The amount of the ash remaining in the crucible was accurately weighed, and the rate of the measured weight to the weight of the sample not yet incinerated was calculated as the ash content (wt %).

### Residue Amount

A PTFE membrane filter with a pore size of 1 μm weighed beforehand was set in a SUS test tube equipped with a pneumatic cap and a gathering funnel produced by Senshu Scientific Co., Ltd., and 100 mg of a PPS resin pressed to form a film with a thickness of about 80 μm and 2 g of 1-chloronaphthalene were placed in the test tube, followed by sealing. The SUS test tube was inserted into high temperature filtration device SSC-9300 produced by Senshu Scientific Co., Ltd., and the filtration device was heated and shaken at 250° C. for 5 minutes, to dissolve the PPS resin into 1-chloronaphthalene. A 20 mL injector containing air was connected with the pneumatic cap, and the piston was extruded to filter the solution by the membrane filter. The membrane filter was taken out and dried in vacuum at 150° C. for 1 hour, subsequently being weighed. The difference between the weight of the membrane filter before filtration and that after filtration was calculated as the residue amount (wt %).

### Melt Flow Rate (MFR)

MFR was measured according to the method specified in ASTM-D1238-70 at a temperature of 315.5° C. and at a load of 5000 g. However, a resin with a low viscosity of more than 1000 g/10 min as MFR is too high in flowability to allow measurement by this measuring method. For the PPS resins low in melt viscosity, the following capillograph was used for measuring the melt viscosity. When the melt viscosity of a PPS resin with an MFR of 500 g/10 min was measured, it was found to be about 80 Pa·s (300° C., shear rate 1000/sec). This indicates that if PPS resins not greatly different in crosslinking degree and not greatly different in the dependence of melt viscosity on shear rate and temperature have melt viscosity values of lower than 80 Pa·s, they have MFR values of higher than 500 g/10 min.

### Melt Viscosity

Capillograph 1C produced by Toyo Seiki Seisaku-Sho, Ltd. was used to measure the melt viscosity at 300° C. using a die with an orifice length of 10.00 mm and an orifice diameter of 0.50 mm.

### Measurement of Cooling Crystallization Temperature (Tmc)

DSC7 produced by Perkin Elmer was used at a heating/cooling rate of 20° C./min in a nitrogen atmosphere using about 10 mg of a sample as follows:
(1) Heating from 50° C. to 340° C. and holding at 340° C. for 1 minute
(2) Cooling to 100° C.
(3) Heating to 340° C. again and holding at 340° C. for 1 minute
(4) Cooling to 100° C. again
   The cooling crystallization peak temperature appearing in (4) was employed as the cooling crystallization temperature (Tmc).

### Molding Stability

One hundred parts by weight of a PPS resin and 67 parts by weight of glass fibers (ECS03TN-103/P produced by Nippon Electric Glass Co., Ltd.) were dry-blended, and TEX30α twin-screw extruder (L/D=45.4) produced by The Japan Steel Works, Ltd. was used for melt-kneading the mixture at a screw speed of 300 rpm by setting the temperature to keep the temperature of the resin delivered from the cylinder at 320° C., and the kneaded resin strand was pelletized by a strand cutter. The pellets were dried at 120° C. overnight and supplied into Fanuc Roboshot α-30i injection molding machine (produced by Fanuc Ltd.), to continuously mold bars (width 12.7 mm, thickness 0.5 mm, side gate 0.5 mm×5.0 mm) under conditions of injection speed 300 mm/sec, injection pressure 40 MPa, cylinder temperature 300° C., mold temperature 150° C., injection time 1 second, cooling time 20 seconds, screw speed 100 rpm, back pressure 1 MPa and suck-back 10 mm, and the lengths of the molded bars were measured as the bar flow lengths. After the first 20 shots were thrown away, the difference between the maximum bar flow length and the minimum bar flow length in 100 shots was obtained. A case where the difference between the maximum bar flow length and the minimum bar flow length accounted for 5% or less of the mean bar flow length of 100 shorts was evaluated to be “excellent (A),” a case where the difference accounted for 5% to 10%, “good (B),” and a case where the difference accounted for more than 10%, “poor (C).”

### Wet Heat Resistance

One hundred parts by weight of a PPS resin and 67 parts by weight of glass fibers (ECS03TN-103/P produced by Nippon Electric Glass Co., Ltd.) were dry-blended, and TEX30α twin-screw extruder (L/D=45.4) produced by The Japan Steel Works, Ltd. was used for melt-kneading the mixture at a screw speed of 300 rpm by setting the temperature to keep the temperature of the resin delivered from the cylinder at 320° C., and the kneaded resin strand was pelletized by a strand cutter. The pellets were dried at 120° C. overnight and molded to prepare specimens of 80 mm×80 mm×2.0 mm thick using injection molding machine UH1000 (produced by Nissei Plastic Industrial Co., Ltd.) at a resin temperature of 300° C. and a mold temperature of 150° C. On an obtained specimen, a copper sheet of 20 mm×20 mm×0.5 mm thick was placed, and they were set in a thermo-hygrostat with a temperature of 60° C. and a humidity of 90%, for wet heat treatment for 10 days (240 hours). After completion of treatment, the copper sheet was visually confirmed. A copper sheet free from any change on the surface was evaluated to be “good (B)” and a copper sheet discolored on the surface, “poor (C).”

### Reference Example 1

### Preparation of PPS-1

An autoclave with a stirrer and a valve at the bottom was charged with 8267.4 g (70.0 moles) of 47.5% sodium hydrosulfide, 2925.0 g (70.2 moles) of 96% sodium hydroxide, 13860.0 g (140.0 moles) of N-methyl-2-pyrrolidone (NMP), 1894.2 g (23.1 moles) of sodium acetate and 10500.0 g of ion exchange water, and while nitrogen was fed at normal pressure, the system was gradually heated to 240° C. taking about 3 hours, to distil away 14772.1 g of water and 280.0 g of NMP. Subsequently, the reaction vessel was cooled to 160° C. The amount of water remaining in the system per 1 mole of the supplied alkali metal sulfide was 1.08 moles including the water consumed for hydrolysis of NMP. Further, the scattered amount of hydrogen sulfide was 0.023 mole per 1 mole of the supplied alkali metal sulfide.

Then, 10646.7 g (72.4 moles) of p-dichlorobenzene (p-DCB) and 6444.9 g (65.1 moles) of NMP were added, and the reaction vessel was sealed under nitrogen gas. With stirring at 240 rpm, the system was heated from 200° C. to 270° C. at a rate of 0.6° C./min, and held at 270° C. for 70 minutes. The ejection valve at the bottom of the autoclave was opened, and under pressurization by nitrogen, the content was flushed into a vessel with a stirrer for 15 minutes and stirred at 250° C. for a while to remove most of NMP.

The obtained solid and 53 liters of ion exchange water were placed in an autoclave with a stirrer and washed at 70° C. for 30 minutes, and suction filtration was performed using a glass filter with a pore size of 10 to 16 μm. Then, 60 liters of ion exchange water heated to 70° C. was poured into a glass filter with a pore size of 10 to 16 μm, to perform suction filtration for obtaining 18000 g of PPS-1 as a cake (containing 7550 g of the PPS resin).

### Reference Example 2

### Preparation of PPS-2

Polymerization was performed as described in Reference Example 1, except that sodium acetate was not added at the time of polymerization, to obtain 16800 g of PPS-2 as a cake (containing 7550 g of the PPS resin).

### Comparative Example 1

PPS-1 was not subjected any of the hot water treatment, acid treatment and thermal oxidation treatment.

### Comparative Example 2

PPS-1 was subjected to the thermal oxidation treatment without being subjected to the hot water treatment and the acid treatment.

The powder of the PPS-1 subjected to the thermal oxidation treatment was placed in a heater with a stirrer having a volume of 100 liters and subjected to the thermal oxidation treatment under the conditions shown in Table 1. Meanwhile, in the thermal oxidation treatment with an oxygen concentration of 12%, 1.0 liter/min of air and 0.96 liter/min of nitrogen were introduced into the heater, and an oxygen concentration meter was installed in the heater for measuring the oxygen concentration.

### Comparative Examples 3 and 4

PPS-1 was subjected to the acid treatment without being subjected to the hot water treatment, and subsequently was not subjected to the thermal oxidation treatment.

In Comparative Examples 3 and 4, an autoclave with a stirrer was charged with 18000 g of PPS-1 as a cake, 40 liters of ion exchange water and 700 g of acetic acid (Comparative Example 3) or 43 g of acetic acid (Comparative Example 4), and the atmosphere in the auto-clave was replaced by nitrogen. Subsequently, the system was heated to 192° C. and kept at the temperature for 30 minutes to perform the acid treatment. The pH during the acid treatment was as shown in Table 1. The autoclave was cooled, and the content was filtered by a glass filter with a pore size of 10 to 16 μm. Then, 60 liters of ion exchange water heated to 70° C. was poured into a glass filter, to perform suction filtration for obtaining a cake. The obtained cake was dried in a nitrogen steam at 120° C. for 4 hours, to obtain a powder of PPS-1 subjected to the acid treatment.

### Working Examples 1 to 4 and Comparative Examples 5 to 11

PPS-1 was subjected to the acid treatment without being subjected to the hot water treatment.

In Working Examples 1 to 4 and Comparative Examples 5 to 11, an autoclave with a stirrer was charged with 18000 g of PPS-1 as a cake, 40 liters of ion exchange water and 700 g of acetic acid (Working Examples 1 and 4 and Comparative Examples 5 and 7 to 10) or 43 g of acetic acid (Working Examples 2 and 3 and Comparative Example 6) or 7 g of acetic acid (Comparative Example 11), and the atmosphere in the autoclave was replaced by nitrogen. Then, the system was heated to 192° C. (Working Examples 1 to 4 and Comparative Examples 5 to 9 and 11) or 70° C. (Comparative Example 10) and kept at the temperature for 30 minutes to perform the acid treatment. The pH during the acid treatment was as shown in Table 1. The autoclave was cooled, and the content was filtered by a glass filter with a pore size of 10 to 16 μm. Subsequently, 60 liters of ion exchange water heated to 70° C. was poured into a glass filter, to perform suction filtration for obtaining a cake. The obtained cake was dried in a nitrogen stream at 120° C. for 4 hours, to obtain a powder of PPS-1 subjected to the acid treatment.

The powder of PPS-1 subjected to the acid treatment was placed in a heater with a stirrer having a volume of 100 liters, and the thermal oxidation treatment was performed under the conditions shown in Table 1. Meanwhile, in the thermal oxidation treatment with an oxygen concentration of 12% (Working Examples 1 and 4 and Comparative Examples 5 and 7 to 11), 1.0 liter/min of air and 0.96 liter/min of nitrogen were introduced into the heater, and an oxygen concentration meter was installed in the heater to measure the oxygen concentration. The thermal oxidation treatment with an oxygen concentration of 21% (Working Examples 2 and 3 and Comparative Example 6) was performed in an air atmosphere with air introduced at 1.96 liters/min.

### Working Examples 5 to 8 and Comparative Example 13

PPS-1 was subjected to the hot water treatment, subsequently to the acid treatment and further subsequently to the thermal oxidation treatment.

In Working Examples 5 to 8 and Comparative Example 13, an autoclave with a stirrer was charged with 18000 g of PPS-1 as a cake and 40 liters of ion exchange water, and the atmosphere in the autoclave was replaced by nitrogen. Then, the system was heated to 192° C. and kept at the temperature for 30 minutes to perform the hot water treatment. The autoclave was cooled, and the content was suction-filtered by a glass filter with a pore size of 10 to 16 μm. Subsequently, 60 liters of ion exchange water heated to 70° C. was poured into a glass filter, to perform suction filtration for obtaining a cake. An autoclave with a stirrer was charged with the obtained cake, 40 liters of ion exchange water and 700 g of acetic acid (Working Examples 5, 7 and 8 and Comparative Example 13) or 43 g of acetic acid (Working Example 6), and the atmosphere in the autoclave was replaced by nitrogen. Then, the system was heated to 192° C. and kept at the temperature for 30 minutes to perform the acid treatment. The pH during the acid treatment was as shown in Table 1. The autoclave was cooled, and subsequently the content was filtered by a glass filter with a pore size of 10 to 16 μm. Then, 60 liters of ion exchange water heated to 70° C. was poured into a glass filter, to perform suction filtration for obtaining a cake. The obtained cake was dried in a nitrogen stream at 120° C. for 4 hours, to obtain a powder of PPS-1 subjected to the hot water treatment and the acid treatment. Then, the powder of PPS-1 subjected to the hot water treatment and the acid treatment was subjected to the thermal oxidation treatment under the conditions shown in Table 1. In the thermal oxidation treatment with an oxygen concentration of 12% (Working Examples 5, 6 and 8) and in the thermal oxidation treatment with an oxygen concentration of 21% (Working Example 7), the air and nitrogen rates were the same as in Working Examples 1 to 4 and Comparative Examples 5 to 11. The thermal oxidation treatment with an oxygen concentration of 0% (Comparative Example 13) was performed in a nitrogen atmosphere with nitrogen introduced at 1.96 liters/min.

### Comparative Example 12

In Comparative Example 12, the hot water treatment and the thermal oxidation treatment were performed by the same methods as described in Working Example 5, except that the acid treatment was not performed.

The measured results of the gas generation amount, ash content, residue amount, MFR and Tmc of each PPS resin obtained are shown in Table 1.

As can be seen from Working Examples 1 to 8, if the pH and temperature for the acid treatment and the temperature, time and oxygen concentration for the thermal oxidation treatment are controlled, a PPS resin small in gas generation amount, ash content and residue amount can be obtained while it can have a melt viscosity in excess of 500 g/10 min as MFR.

Further, the evaluation results of molding stability and wet heat resistance are also shown in Table 1. It can be seen that only when a PPS resin small in gas generation amount, ash content and residue amount and with an MFR of higher than 500 g/10 min is used, molding stability and wet heat resistance become good.

On the other hand, in Comparative Example 1, since the acid treatment was not performed, the MFR was low and the ash content was large. Further, since the thermal oxidation treatment was not performed, the gas generation amount was large. In Comparative Example 2, since the acid treatment was not performed though the thermal oxidation treatment was performed, the MFR was low and the ash content was large. In Comparative Examples 3 and 4, since the thermal oxidation treatment was not performed though the acid treatment was performed, the gas generation amount was large. In Comparative Examples 5 and 6, since thermal oxidation treatment temperature was too low, the gas generation amount was large. In Comparative Example 7, since the thermal oxidation treatment time was too short, the gas generation amount was large. In Comparative Example 8, since the thermal oxidation treatment time was too long, the residue amount was large and the MFR was low. In Comparative Example 9, since the thermal oxidation treatment temperature was too high, the residue amount was large and the MFR was low. In Comparative Example 10, since the acid treatment temperature was woo low, the ash content was large and the MFR was low. In Comparative Example 11, since the acid treatment effect was not exhibited owing to an alkaline pH, the ash content was large and the MFR was low. In Comparative Example 12, since the acid treatment was not performed, the ash content was large and the MFR was low. In Comparative Example 13, since the oxygen concentration during the thermal oxidation treatment was too low, the impurity removal effect by oxidation was low and the gas generation amount was large.

Since Comparative Examples 1 to 13 have these problems, it can be seen from Table 1 that good results could not be obtained in the evaluation of molding stability and wet heat resistance.

TABLE 1

| | | | Comparative Example | | | | | | | | |
|---|---|---|---|---|---|---|---|---|---|---|---|
| | | | 1 | 2 | 3 | 4 | 5 | 6 | 7 | 8 | 9 |
| PPS used | | | PPS-1 | PPS-1 | PPS-1 | PPS-1 | PPS-1 | PPS-1 | PPS-1 | PPS-1 | PPS-1 |
| Hot water treatment | Temp. | ° C. | — | — | — | — | — | — | — | — | — |
| Acid | Treat pH | | — | — | 4 | 7 | 4 | 7 | 4 | 4 | 4 |
| treatment | Temp. | ° C. | — | — | 192 | 192 | 192 | 192 | 192 | 192 | 192 |
| Thermal | Temp. | ° C. | — | 200 | — | — | 110 | 150 | 200 | 200 | 280 |
| oxidation | Time | hours | — | 4 | — | — | 2 | 2 | 0.1 | 60 | 1 |
| treatment | Oxygen concentration | % | — | 12 | — | — | 12 | 21 | 12 | 12 | 12 |

| | | | | | | | | | | |
|---|---|---|---|---|---|---|---|---|---|---|
| Gas generation | wt % | 0.69 | 0.26 | 0.90 | 0.54 | 0.85 | 0.51 | 0.80 | 0.05 | 0.09 |
| amount¹⁾ | | | | | | | | | | |
| Ash content²⁾ | wt % | 2.58 | 2.30 | 0.01 | 0.14 | 0.01 | 0.14 | 0.01 | 0.01 | 0.01 |
| Residue | wt % | 2.5 | 2.6 | 1.5 | 1.5 | 1.5 | 1.5 | 1.7 | 6.2 | 5.8 |
| amount³⁾ | | | | | | | | | | |
| MFR⁴⁾ | g/10 min | 360 | 330 | 750 | 720 | 740 | 718 | 690 | 210 | 220 |
| Tmc | ° C. | 195 | 197 | 242 | 220 | 240 | 219 | 239 | 225 | 230 |

| | | | | | | | | | |
|---|---|---|---|---|---|---|---|---|---|
| Molding stability⁵⁾ | C | C | C | C | C | C | C | C | C |
| Wet heat resistance⁶⁾ | C | C | C | C | C | C | C | C | C |

Comparative Example

| | | | | |
|---|---|---|---|---|
| | 10 | 11 | 12 | 13 |
| PPS used | PPS-1 | PPS-1 | PPS-1 | PPS-1 |

| | | | | | | |
|---|---|---|---|---|---|---|
| Hot water treatment | Temp. | ° C. | — | — | 192 | 192 |
| Acid | Treat pH | | 4 | 10 | — | 4 |
| treatment | Temp. | ° C. | 70 | 192 | — | 192 |
| Thermal | Temp. | ° C. | 200 | 200 | 200 | 180 |
| oxidation | Time | hours | 2 | 2 | 2 | 4 |
| treatment | Oxygen concentration | % | 12 | 12 | 12 | 0 |

| | | | | | |
|---|---|---|---|---|---|
| Gas generation | wt % | 0.21 | 0.20 | 0.20 | 0.58 |
| amount¹⁾ | | | | | |
| Ash content²⁾ | wt % | 1.95 | 2.10 | 2.20 | 0.01 |
| Residue | wt % | 2.1 | 2.1 | 2.0 | 1.6 |
| amount³⁾ | | | | | |
| MFR⁴⁾ | g/10 min | 320 | 310 | 310 | 60 |
| Tmc | ° C. | 200 | 197 | 197 | 240 |

| | | | | |
|---|---|---|---|---|
| Molding stability⁵⁾ | C | C | C | C |
| Wet heat resistance⁶⁾ | C | C | C | C |

Sequel of Table 1

| | | | Working Example | | | | | | | |
|---|---|---|---|---|---|---|---|---|---|---|
| | | | 1 | 2 | 3 | 4 | 5 | 6 | 7 | 8 |
| PPS used | | | PPS-1 | PPS-1 | PPS-1 | PPS-1 | PPS-1 | PPS-1 | PPS-1 | PPS-1 |
| Hot water treatment | Temp. | ° C. | — | — | — | — | 192 | 192 | 192 | 192 |
| Acid treatment | Treat pH | | 4 | 7 | 7 | 4 | 4 | 7 | 4 | 4 |
| | Temp. | ° C. | 192 | 192 | 192 | 192 | 192 | 192 | 192 | 192 |
| Thermal oxidation treatment | Temp. | ° C. | 200 | 200 | 200 | 240 | 200 | 200 | 180 | 180 |
| | Time | hours | 2 | 1 | 2 | 1 | 2 | 2 | 4 | 4 |
| | Oxygen concentration | % | 12 | 21 | 21 | 12 | 12 | 12 | 21 | 12 |

| | | | | | | | | | |
|---|---|---|---|---|---|---|---|---|---|
| Gas generation amount¹⁾ | wt % | 0.28 | 0.22 | 0.16 | 0.20 | 0.24 | 0.20 | 0.23 | 0.24 |
| Ash content²⁾ | wt % | 0.01 | 0.14 | 0.14 | 0.01 | 0.01 | 0.14 | 0.01 | 0.01 |
| Residue amount³⁾ | wt % | 2.1 | 1.8 | 1.9 | 2.2 | 2.1 | 2.2 | 2.4 | 2.2 |
| MFR⁴⁾ | g/10 min | 580 | 618 | 554 | 510 | 550 | 510 | 540 | 550 |
| Tmc | ° C. | 238 | 215 | 215 | 238 | 237 | 219 | 237 | 237 |

| | | | | | | | | |
|---|---|---|---|---|---|---|---|---|
| Molding stability⁵⁾ | B | B | B | B | A | A | A | A |
| Wet heat resistance⁶⁾ | B | B | B | B | B | B | B | B |

### Comparative Example 14

PPS-2 was not subjected to any of the hot water treatment, acid treatment and thermal oxidation treatment.

### Comparative Example 15

PPS-2 was subjected to the thermal oxidation treatment without being subjected to the hot water treatment and the acid treatment.

In Comparative Example 15, an experiment was performed as described in Comparative Example 2, except that PPS-2 was used.

### Comparative Examples 16 and 17

PPS-2 was subjected to the acid treatment without being subjected to the hot water treatment, and subsequently was not subjected to the thermal oxidation treatment.

In Comparative Example 16, an experiment was performed as described in Comparative Example 3 except that PPS-2 was used. The pH for the acid treatment was as shown in Table 2.

In Comparative Example 17, an experiment was performed as described in Comparative Example 4 except that PPS-2 was used. The pH for the acid treatment was as shown in Table 2.

### Working Examples 9 to 11 and Comparative Example 18

PPS-2 was subjected to the acid treatment without being subjected to the hot water treatment, and subsequently was subjected to the thermal oxidation treatment.

In Working Example 9, an experiment was performed as described in Working Example 1 except that PPS-2 was used. The pH for the acid treatment was as shown in Table 2.

In Working Example 10, an experiment was performed as described in Working Example 2 except that PPS-2 was used and that the thermal oxidation treatment was performed for 6 hours. The pH for the acid treatment was as shown in Table 2.

In Working Example 11, an experiment was performed as described in Working Example 4 except that PPS-2 was used. The pH for the acid treatment was as shown in Table 2.

In Comparative Example 18, an experiment was performed as described in Comparative Example 9 except that PPS-2 was used and that 43 g of acetic acid was used for the acid treatment. The pH for the acid treatment was as shown in Table 2.

### Working Examples 12 to 15

PPS-2 was subjected to the hot water treatment, subsequently to the acid treatment and further subsequently to the thermal oxidation treatment.

In Working Example 12, an experiment was performed as described in Working Example 5 except that PPS-2 was used. The pH for the acid treatment was as shown in Table 2.

In Working Example 13, an experiment was performed as described in Working Example 6 except that PPS-2 was used. The pH for the acid treatment was as shown in Table 2.

In Working Example 14, an experiment was performed as described in Working Example 7 except that PPS-2 was used and that the thermal oxidation treatment was performed at 200° C. for 2 hours. The pH for the acid treatment was as shown in Table 2.

In Working Example 15, an experiment was performed as described in Working Example 8 except that PPS-2 was used. The pH for the acid treatment was as shown in Table 2.

The measured results of the gas generation amount, ash content, residue amount, MFR and Tmc of each PPS resin obtained are shown in Table 2.

As can be seen from Working Examples 9 to 15 that use PPS-2 lower than PPS-1 in melt viscosity, since the pH and temperature for the acid treatment, the temperature, time and oxygen concentration for the thermal oxidation treatment are controlled, the PPS resin obtained is small in gas generation amount, ash content and residue amount though it has a melt viscosity in excess of 500 g/10 min as MFR.

Further, the evaluation results of molding stability and wet heat resistance are also shown in Table 2. It can be seen that only when a PPS resin small in gas generation amount, ash content and residue amount and with an MFR of higher than 500 g/10 min is used, molding stability and wet heat resistance become good.

On the other hand, in Comparative Example 14, since the acid treatment was not performed, the ash content was large, and further since the thermal oxidation treatment was not performed, the gas generation amount was large. In Comparative Example 15, since the acid treatment was not performed through the thermal oxidation treatment was performed, the ash content was large. In Comparative Examples 16 and 17, since the thermal oxidation treatment was not performed though the acid treatment was performed, the gas generation amount was large. In Comparative Example 18, since the thermal oxidation treatment temperature was too high, the residue amount was large and the MFR was low.

Since Comparative Examples 14 to 18 have these problems, it can be seen from Table 2 that good results could not be obtained in the evaluation of molding stability and wet heat resistance.

TABLE 2

| | | | Comparative Example | | | | | Working Example | | | | | | |
|---|---|---|---|---|---|---|---|---|---|---|---|---|---|---|
| | | | 14 | 15 | 16 | 17 | 18 | 9 | 10 | 11 | 12 | 13 | 14 | 15 |
| PPS used | | | PPS-2 | PPS-2 | PPS-2 | PPS-2 | PPS-2 | PPS-2 | PPS-2 | PPS-2 | PPS-2 | PPS-2 | PPS-2 | PPS-2 |
| Hot water | Temp. | ° C. | — | — | — | — | — | — | — | — | 192 | 192 | 192 | 192 |
| treatment | | | | | | | | | | | | | | |
| Acid | Treat pH | | — | — | 4 | 7 | 7 | 4 | 7 | 4 | 4 | 7 | 4 | 4 |
| treatment | Temp. | ° C. | — | — | 192 | 192 | 192 | 192 | 192 | 192 | 192 | 192 | 192 | 192 |
| Thermal | Temp. | ° C. | — | 200 | — | — | 280 | 200 | 200 | 240 | 200 | 200 | 200 | 180 |
| oxidation | Time | hours | — | 4 | — | — | 1 | 2 | 6 | 1 | 2 | 2 | 2 | 4 |
| treatment | Oxygen | % | — | 12 | — | — | 12 | 12 | 21 | 12 | 12 | 12 | 21 | 12 |
| | concentration | | | | | | | | | | | | | |

| | | | | | | | | | | | | | |
|---|---|---|---|---|---|---|---|---|---|---|---|---|---|
| Gas | wt % | 0.92 | 0.29 | 1.90 | 0.93 | 0.10 | 0.29 | 0.22 | 0.22 | 0.24 | 0.22 | 0.23 | 0.24 |
| generation | | | | | | | | | | | | | |
| amount¹⁾ | | | | | | | | | | | | | |
| Ash | wt % | 2.00 | 1.98 | 0.05 | 0.23 | 0.23 | 0.05 | 0.23 | 0.05 | 0.05 | 0.23 | 0.05 | 0.05 |
| content²⁾ | | | | | | | | | | | | | |
| Residue | wt % | 2.0 | 2.0 | 1.5 | 1.5 | 5.8 | 2.1 | 1.9 | 2.3 | 2.1 | 2.2 | 2.4 | 2.2 |
| amount³⁾ | | | | | | | | | | | | | |
| MFR⁴⁾ | g/10 min | >500 | >500 | >500 | >500 | 280 | >500 | >500 | >500 | >500 | >500 | >500 | >500 |
| Melt | Pa · s | 7 | 12 | 5 | 5 | >80 | 11 | 15 | 14 | 10 | 15 | 12 | 10 |
| viscosity | | | | | | | | | | | | | |
| Tmc | ° C. | 190 | 193 | 238 | 220 | 210 | 233 | 215 | 233 | 234 | 220 | 234 | 234 |

| | | | | | | | | | | | | |
|---|---|---|---|---|---|---|---|---|---|---|---|---|
| Molding stability⁵⁾ | C | C | C | C | C | B | B | B | A | A | A | A |
| Wet heat resistance⁶⁾ | C | C | C | C | C | B | B | B | B | B | B | B |

In Tables 1 and 2:
¹⁾Good . . . Gas generation amount = or <0.3 wt % Poor . . . Gas generation amount >0.3 wt %
²⁾Good . . . Ash content = or <0.3 wt % Poor . . . Ash content >0.3 wt %
³⁾Good . . . Residue amount = or <4.0 wt % Poor . . . Residue amount >4.0 wt %
⁴⁾Good . . . MFR >500 g/10 min Poor . . . MFR = or <500 g/10 min
⁵⁾Excellent (A) . . . Flowability variation = or <5% Good (B) . . . Flowability variation = 5 to 10% Poor (C) . . . Flowability variation >10%
⁶⁾Good (B) . . . Not changed on the surface of copper sheet Poor (C) . . . Discolored on the surface of copper sheet

### INDUSTRIAL APPLICABILITY

A PPS resin excellent in melt flowability, small in metal content and in the amount of the volatile component generated during melting and excellent in molding stability and wet heat resistance can be obtained.

1. A process for producing a polyphenylene sulfide resin with properties of (1) 0.3 wt % or less in an amount of volatile gas generated when heated and melted at 320° C. in a vacuum for 2 hours, (2) 0.3 wt % or less in ash content achieved when incinerated at 550° C., (3) 4.0 wt % or less in residue amount achieved when a solution with 1 part by weight of the polyphenylene sulfide resin dissolved in 20 parts by weight of 1-chloronaphthalene is pressure-filtered by a PTFE membrane filter with a pore size of 1 μm at 250° C. for 5 minutes, and (4) higher than 500 g/10 min in melt flow rate (according to ASTM D-1238-70: measured at a temperature of 315.5° C. and at a load of 5000 g), by acid-treating a polyphenylene sulfide resin in an acid treatment step and subsequently treating it for thermal oxidation in a thermal oxidation step.

2. The process according to claim 1, wherein, in the acid treatment step, the polyphenylene sulfide resin is immersed in an acid or an aqueous solution of the acid for treatment.

3. The process according to claim 1, wherein, in the acid treatment step, the polyphenylene sulfide resin is immersed in an acid or an aqueous solution of the acid for treatment at pH 2 to 8 and at 80 to 200° C.

4. The process according to claim 1, wherein the step of treating the polyphenylene sulfide resin by hot water at 80 to 200° C. is performed before the step of acid-treating the polyphenylene sulfide resin.

5. The process according to claim 1, wherein, in the step of treating the polyphenylene sulfide resin for thermal oxidation, the polyphenylene sulfide resin is heat-treated in an atmosphere with an oxygen concentration of 2 vol % or more at 160 to 270° C. for 0.5 to 10 hours.

6. The process according to claim 1, wherein the polyphenylene sulfide resin is a resin recovered by a flush method.

7. The process according to claim 2, wherein, in the acid treatment step, the polyphenylene sulfide resin is immersed in an acid or an aqueous solution of the acid for treatment at pH 2 to 8 and at 80 to 200° C.

8. The process according to claim 2, wherein the step of treating the polyphenylene sulfide resin by hot water at 80 to 200° C. is performed before the step of acid-treating the polyphenylene sulfide resin.

9. The process according to claim 3, wherein the step of treating the polyphenylene sulfide resin by hot water at 80 to 200° C. is performed before the step of acid-treating the polyphenylene sulfide resin.

10. The process according to claim 2, wherein, in the step of treating the polyphenylene sulfide resin for thermal oxidation, the polyphenylene sulfide resin is heat-treated in an atmosphere with an oxygen concentration of 2 vol % or more at 160 to 270° C. for 0.5 to 10 hours.

11. The process according to claim 3, wherein, in the step of treating the polyphenylene sulfide resin for thermal oxidation, the polyphenylene sulfide resin is heat-treated in an atmosphere with an oxygen concentration of 2 vol % or more at 160 to 270° C. for 0.5 to 10 hours.

12. The process according to claim 4, wherein, in the step of treating the polyphenylene sulfide resin for thermal oxidation, the polyphenylene sulfide resin is heat-treated in an atmosphere with an oxygen concentration of 2 vol % or more at 160 to 270° C. for 0.5 to 10 hours.

13. The process according to claim 2, wherein the polyphenylene sulfide resin is a resin recovered by a flush method.

14. The process according to claim 3, wherein the polyphenylene sulfide resin is a resin recovered by a flush method.

15. The process according to claim 4, wherein the polyphenylene sulfide resin is a resin recovered by a flush method.

16. The process according to claim 5, wherein the polyphenylene sulfide resin is a resin recovered by a flush method.
